(19) United States
(12) Patent Application Publication
(10) Pub. No.: US 2004/0022022 A1
(43) Pub. Date: Feb. 5, 2004

(54) Modular system customized by system backplane

(76) Inventor: Brendan A. Voge, Granite Bay, CA (US)

Correspondence Address: HEWLETT-PACKARD COMPANY, Intellectual Property Administration, P.O. Box 272400, Fort Collins, CO, 80527-2400, US

(21) Appl. No.: 10/210,095

(22) Filed: Aug. 2, 2002

(51) Int. Cl. G06F 1/16

(52) U.S. Cl. 361/684; 361/724

(57) ABSTRACT

A system comprising a plurality of modular cells, each modular cell having a predetermined number of connectors, and a backplane coupled to the plurality of modular cells in a specific configuration such that the performance characteristics of the system are determined solely by the specific configuration of the backplane, the backplane including a plurality of cache coherent links that directly interconnects every modular cell in the system.

### TECHNICAL FIELD

This invention relates generally to multiprocessor systems and means for configuring clusters of processors.

### BACKGROUND

In many data processing systems (e.g., computer systems, programmable electronic systems, telecommunication switching systems, and control systems, for example) multiprocessor configurations are used. Such multiprocessor (MP) configurations comprise multiple processor modules (frequently referred to as processor cells). One common multiprocessor configuration is called a symmetric multiprocessor (SMP) system. Other common multiprocessor configurations include non-symmetric multiprocessor (non-SMP) system. Another example of non-SMP systems are clusters of processors that communicate but do not share memory address space.

MP systems may be designed to optimize several different attributes of the system, e.g., system size, performance characteristics, availability, reliability, and cost effectiveness. Currently, in developing MP systems with different attributes, system architects have to spend a significant amount of time designing and building modules or cells that are unique for that design. In addition to time considerations, such extensive redesigns can also be very expensive. Also, the need to produce and stock the different types of cells that may be necessary to construct the different system designs can cause a significant strain on the resources of component and system manufactures.

### SUMMARY

In contrast to cells used in an MP system, which can contribute to over half the cost of a system, the system backplane is much less expensive to reconfigure. Typically, backplanes do not contain many components other than connectors that allow the backplane to receive the requisite cells. If a system could be redesigned by merely reconfiguring the backplane without having to similarly redesign the associated cells, the costs of upgrading or redesigning the entire system could be significantly reduced.

The system disclosed in the present application is advantageous in that it allows system upgrades and system redesigns to be accomplished at reduced cost to both the consumer and the manufacturer. The system is also advantageous in that the system provides flexibility for different customer usage models and requirements, multiple performance points, availability, or reliability attributes with a minimum number of unique assemblies, resulting in reduced development costs, and reduced manufacturing costs due to higher volumes.

These and other advantages are achieved in a system that includes a plurality of modular cells, each modular cell having a predetermined number of connectors. The system also includes a backplane coupled to the plurality of modular cells in a specific configuration such that the performance characteristics of the system are determined solely by the specific configuration of the backplane, the backplane including a plurality of cache coherent links that directly interconnects every modular cell in the system.

These and other advantages are further achieved in a system that includes processing means for processing signals in the system. The system also includes interconnecting means for interconnecting the processing means with a plurality of cache coherent links such that the performance characteristics of the system are determined solely by the interconnecting means.

These and other advantages are also achieved in a system that includes a plurality of memories, a plurality of input/output devices, and a plurality of processors. Each processor is operably connected to at least one of the plurality of memories and at least one of the plurality of input/output devices. The system also includes a backplane coupled to the plurality of processors in a specific configuration such that the performance characteristics of the system are determined solely by the specific configuration of the backplane, the backplane including a plurality of cache coherent links that directly interconnects every processor in the system.

### DESCRIPTION OF THE DRAWINGS

FIG. 1 is a diagram of one embodiment of a modular cell for use in a multiprocessor system;

FIG. 2 is a diagram of another embodiment of a modular cell for use in a multiprocessor system;

FIG. 3A is a diagram of a modular processor cell;

FIG. 3B is a diagram of a modular memory cell;

FIG. 3C is a diagram of a modular input/output cell;

FIG. 4 is a diagram of a multiprocessor system having a passive backplane;

FIG. 5 is a diagram of a multiprocessor system having a crossbar backplane;

FIG. 6 is a diagram of a multiprocessor system having a passive backplane interconnected in a “ring” topology; and

FIG. 7 is a diagram of a multiprocessor system having a passive backplane interconnected in a “mesh” topology.

### DETAILED DESCRIPTION

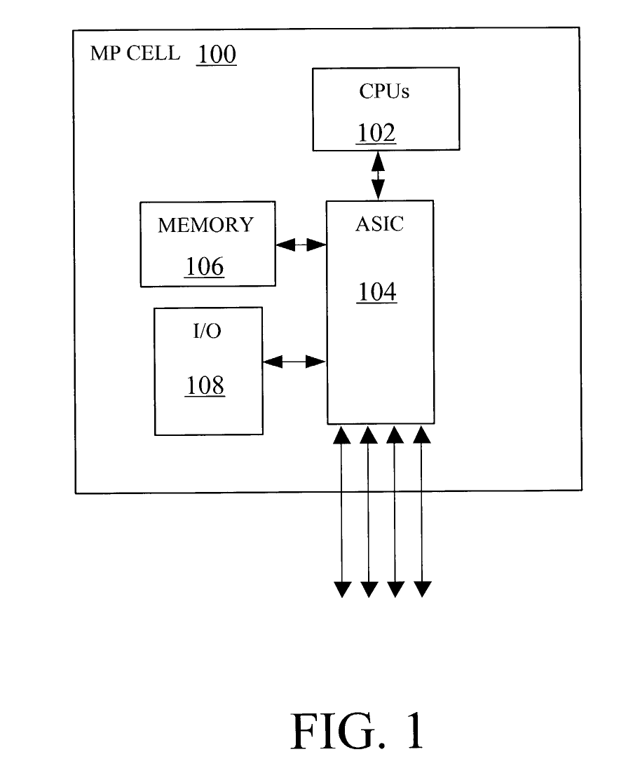

FIG. 1 illustrates a modular cell 100 that can be used in a multiprocessor system. Cell 100 comprises a central processor unit (CPU) 102, an application specific integrated circuit (ASIC) 104, a memory module 106, and an input/output (I/O) module 108. The ASIC 104 communicates with a system backplane to receive and transmit external data and instructions through a number of connectors (indicated by the arrows), and the data and instructions are, in turn, received and transmitted by the CPU 102, the memory module 106, and the I/O module 108. Cell 100 has sufficient resources to be a stand-alone system (since the cell 100 has the three basic components CPU 102, memory module 106, and I/O module 108). The connectors from cell to backplane can be single wires or sets of wires (often called ‘links’).

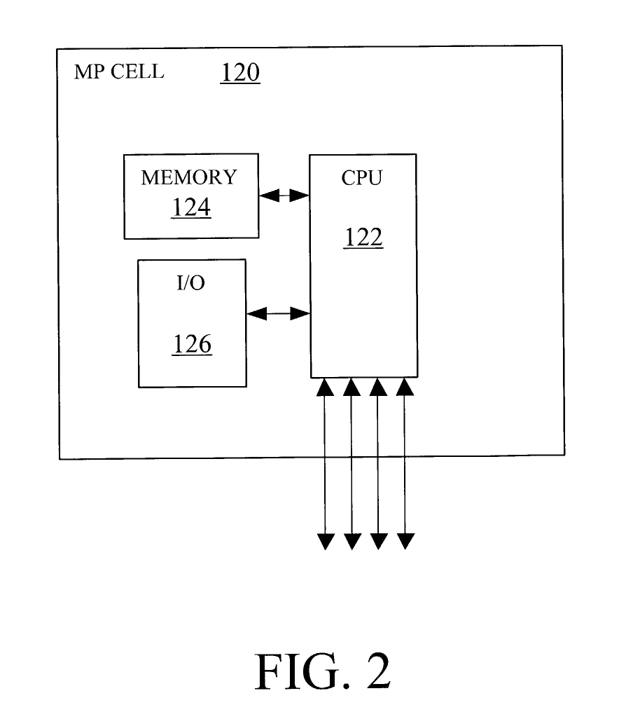

FIG. 2 illustrates another embodiment of the modular cell that foregoes the use of an ASIC to receive and transmit external data and instructions. Cell 120 comprises a CPU 122, a memory module 124, and an I/O module 126. In this embodiment, the CPU 122 directly receives and transmits external data and instructions to and from the system backplane through a number of connectors (indicated by the arrows). The benefits of cell 120 are lower manufacturing cost since there are fewer components within cell 120. However, there is a cost increase associated with this embodiment since the CPU 122 must be larger than the CPU 102 in the embodiment in which the ASIC 104 performs communication functions. Also and have an increased number of pins to perform both processing and communication functions.

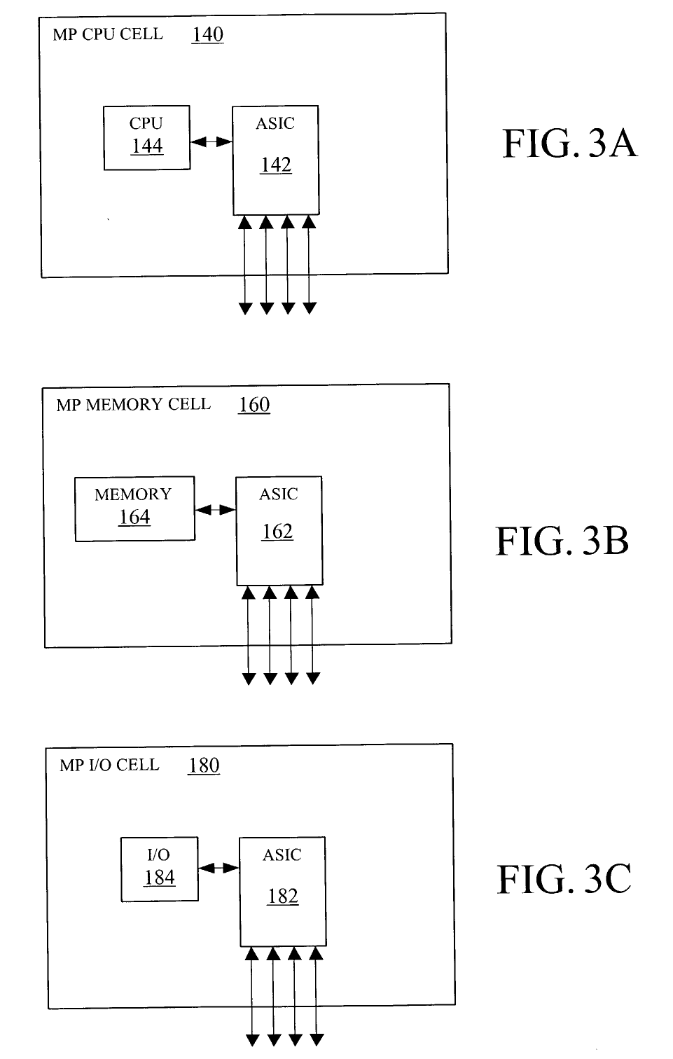

FIGS. 3A-C illustrate further embodiments of the modular cell, where each modular cell is responsible for only one particular type of function. Processor cell 140 in FIG. 3A comprises ASIC 142 and CPU 144 and carries out processing functions only. Memory cell 160, in FIG. 3B, comprises ASIC 162 and memory module 164 and is responsible for memory functions. I/O cell 180, in FIG. 3C, comprises ASIC 182 and I/O module 184 and functions as an input/output device. The ASIC modules in each type of cell facilitate communication with the system backplane through a number of connectors (indicated by the arrows). If these function specific cells 140, 160, and 180 are used to populate the system backplane, rather than multifunctional cells 100 or 120, each of which contain processing, memory, and I/O components, then three times the number of cells will be needed for a particular system in order to provide the same functionality as multifunctional cells 100 or 120. The large number of cells may increase communication latency times between cells, thus slowing down the system, as well as increasing the cost of the system. However, using function specific cells 140, 160, and 180 does provide more flexibility in system configuration, allowing system designers, integrators and customers to determine the right mix of CPU, memory and I/O depending on the specific application. Replacements required when a specific component breaks down or needs to be upgraded become simpler and less expensive because only one cell, i.e. an isolated CPU cell, rather than an entire multifunctional cell, needs to be replaced.

The various types of modular cells described above can be interconnected in various topologies described below to create MP systems. In the topologies described below, the modular cells are interconnected with cache coherent links rather than with local area networks (LANs). A cache coherent link is a communication channel between at least two system with a protocol that allows read and write access to a shared memory space. The protocol allows for the memory space to be locally cached and still retain an identical view of the shared memory such that the cache are always consistent with one another. Therefore, when reading the same memory location, the result is always the same regardless of which processor does the reading and regardless of which cache the data comes from. This is in contrast to LANs in which two interconnected system can send messages to each other but cannot read or write each other's memory.

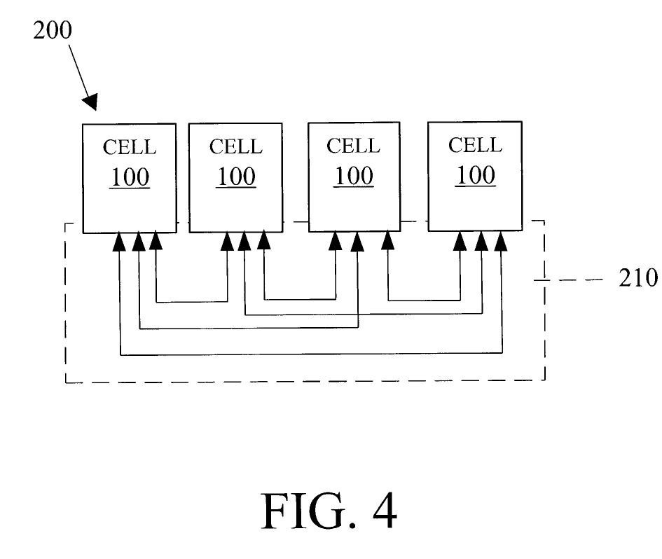

FIG. 4 illustrates a MP system 200 that comprises a number of cells 100, connected together by way of a passive backplane 210. The passive backplane 210 includes only wires. Backplane 210 is shown by the dotted line. Cells 100 are shown by way of example, although any of the previously described cells, e.g., cell 120 or cells 140, 160, and 180, could be used. Every cell 100 is connected to every other cell 100 by way of a direct wire connection between the ASIC modules 104 of each individual cell 100. Although a single wire connection between cells 100 is illustrated in FIG. 4, there can be two or more direct connections between cells 100, allowing for greater bandwidth communication between cells 100.

MP system 200 is an example of a low cost, small system using the passive backplane to directly interconnect the cells using cache coherent links. This embodiment of the system is optimized for low cost and best availability. The system is more economical since the backplane consists only of wires and has no other components. Availability is improved since the backplane has no unreliable active components, and a failure in one cell will not prevent other cells from communicating. The limitation in this system design is that it is difficult to upgrade the size of the system since additional wires and connections to and from the modular cells 100 are required for each additional modular cell 100 that is added into the system.

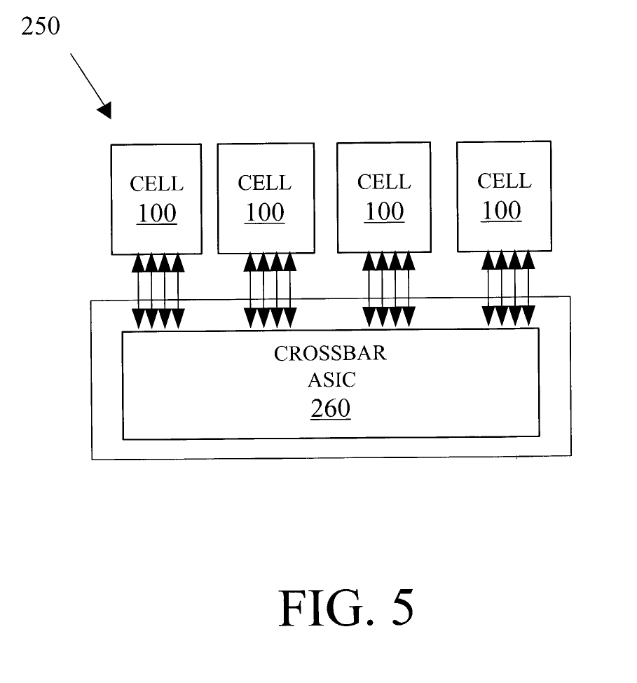

FIG. 5 illustrates a MP system 250 that comprises a number of cells 100, connected together by way of a crossbar ASIC backplane 260. A crossbar is a specific type of multi-ported electronic switch that allows multiple independent communications to occur simultaneously between any two non-busy ports. For example, an eight port crossbar would allow port 1 to communicate with port 4, while at the same time port 3 can talk with port 2. Simultaneously, port 5 can talk with port 8 and port 6 can talk with port 7. Crossbar ASIC backplane 260 is shown by the dotted line. As before, cells 100 are shown by way of example. Each cell 100 is connected to crossbar backplane 260 by way of several connections or cache coherent links between the ASIC modules 104 of each individual cell 100 and crossbar ASIC backplane 260. Four links are illustrated in FIG. 5, however, each cell 100 may have more or a fewer number of links. A fewer number of links to the crossbar ASIC backplane 260 will reduce the cost of the system but will also reduce the performance of the system by decreasing the allotted bandwidth of the connection between the modular cells 100 and the crossbar ASIC backplane 260.

This MP system embodiment is optimized for performance since the crossbar backplane 260 allows all cache coherent links from each cell to be “ganged” together for higher bandwidth communication. Availability is compromised, however, since any failure in the crossbar backplane 260 will prevent all cells from communicating to each other. A larger system could be built using a larger crossbar ASIC backplane 260 that contains more ports, allowing for easy size upgrades. The larger system would only require the larger backplane, while still utilizing the same cells 100 from the smaller system, and any additional cells 100 that are required. Furthermore, there can be several versions of the same sized crossbar ASIC backplane 260. For example, one version of the crossbar ASIC backplane 260 may have more features in the ASIC that provides better security for the MP system while another version of the crossbar ASIC backplane 260 could provide better resistance to failures.

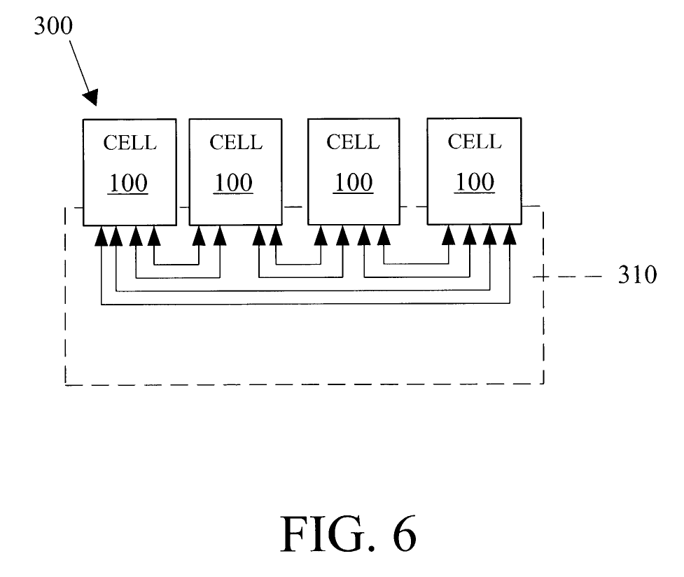

FIG. 6 illustrates a MP system 300 that comprises a number of cells 100 connected together by way of a passive backplane 310. The passive backplane 310 includes only wires, arranged in a “ring” topology. Backplane 310 is shown by the dotted line. As before, cells 100 are shown byway of example. Each cell 100 is connected to each adjacent cell 100 by way of a direct wire connection between the ASIC modules 104 of each individual cell 100. Also, the first and last cells 100 in the system may be connected (as shown) or may be left unconnected. Although a double wire connection between cells 100 is illustrated in FIG. 6, there can be a single connection or several direct connections between cells 100, limiting and expanding the bandwidth communication between cells 100, respectively. Empty slots in the backplane (slots with no cell plugged in) are bypassed with a “jumper” or wire connection that crosses the gap in the ring.

MP system 300 is optimized for cost due to the passive nature of the backplane (wires on a PC board or cables). MP system 300 is also optimized for expandability, since more cells can be inserted into the ring simply by adding no more than two additional connections to the new cell from the existing adjacent cell(s), in the situation of a single connection between cells. This embodiment sacrifices performance, however, since each additional cell adds latency, i.e., an additional link or “hop” for every processor cell added, and each “hop” costs additional time, reducing performance and consuming some of the bandwidth of the ring interconnect.

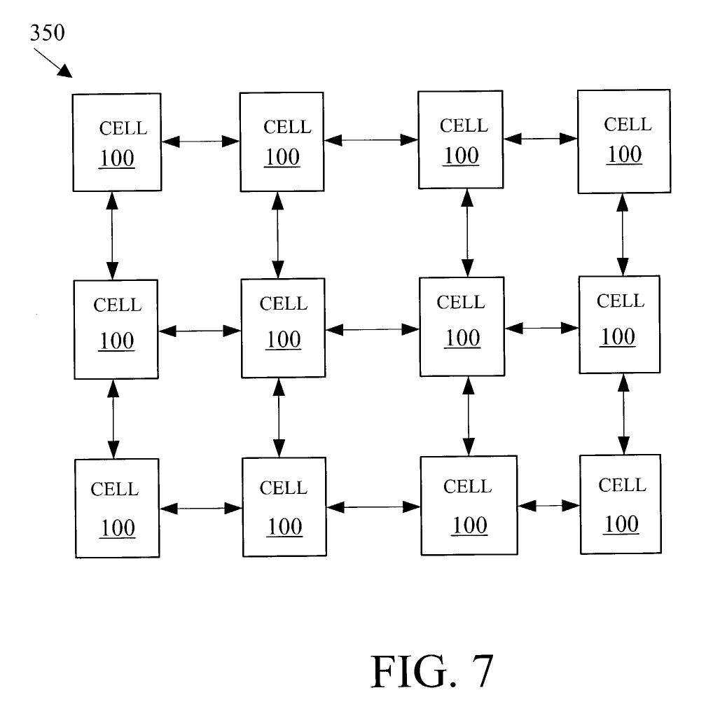

FIG. 7 illustrates a MP system 350 that comprises multiple cells 100 arranged in a two-dimensional matrix or “mesh” though an interconnection of wires. For clarity, the backplane outline has been omitted from FIG. 7. As before, cells 100 are shown by way of example. Each cell 100 is connected to each other cell 100 by way of direct wire connections or cache coherent links between the ASIC modules 104 of each individual cell 100. The connections may be provided using one or more links, allowing for differing communication bandwidths between the cells 100. In the simplest case, where only a single link is used to connects the cells 100, no more than four links is required to connect a cell 100 to the mesh.

This embodiment is optimized for network expandability and performance in a cost-efficient multiprocessor configuration. New cells can easily be added to outlying cells already in the configuration without requiring a new backplane, as opposed to the crossbar backplane embodiment where size expansion does require a different backplane. Also, the latency problem that arises in the “ring” topology embodiment is not as noticeable in the mesh arrangement. Although each additional cells adds a “hop”, the total latency only increases as the square root of the size of the number of cells since the cells are being added in two-dimensions rather than just in one-dimension.

The foregoing description of the present invention provides illustration and description, but is not intended to be exhaustive or to limit the invention to the precise one disclosed. Modifications and variations are possible consistent with the above teachings or may be acquired from practice of the invention. Thus, it is noted that the scope of the invention is defined by the claims and their equivalents.

What is claimed is:

1. A system comprising:
a plurality of modular cells, each modular cell having a predetermined number of connectors; and
a backplane coupled to the plurality of modular cells in a specific configuration such that the performance characteristics of the system are determined solely by the specific configuration of the backplane, the backplane including a plurality of cache coherent links that directly interconnects every modular cell in the system.

2. The system of claim 1, wherein the amount of the predetermined number of connections that are utilized determines the quality of the performance of the system.

3. The system of claim 2, wherein the backplane connects to fewer than the predetermined number of connectors in the plurality of modular cells.

4. The system of claim 1, wherein the backplane directly connects immediately adjacent modular cells.

5. The system of claim 4, further comprising a first modular cell and a last modular cell, wherein the backplane connects the first modular cell to the last modular cell.

6. The system of claim 4, further comprising slots in the backplane in which the modular cells are inserted, wherein slots not populated with a modular cell are bypassed with a direct link between modular cells immediately adjacent to the unpopulated slot.

7. The system of claim 1, wherein the backplane directly connects immediately adjacent modular cells in a plurality of directions.

8. The system of claim 7, wherein the modular cells are arranged in a two-dimensional array configuration such that the modular cells are connected in both an x-direction and a y-direction.

9. The system of claim 1, wherein the backplane is a crossbar integrated circuit.

10. The system of claim 9, wherein the crossbar integrated circuit has features that provides better security for the system.

11. The system of claim 9, wherein the crossbar integrated circuit has features that provide improved resistance to failures in the system.

12. The system of claim 1, wherein the modular cells comprise a processor.

13. The system of claim 12, wherein the modular cells further comprise an interface that operably connects the modular cell to the backplane.

14. The system of claim 13, wherein the interface is the processor.

15. The system of claim 13, wherein:
the modular cells further comprise an application specific integrated circuit operably connected to the processor; and
the interface is the application specific integrated circuit.

16. The system of claim 13, wherein the modular cells further comprise a memory operably connected to the processor.

17. The system of claim 13, wherein the modular cells further comprise an input/output device operably connected to the processor.

18. The system of claim 1, wherein the modular cells separately comprise at least one function specific component, the at least one function specific component including at least one of a processor, a memory, and an input/output device.

19. A system comprising:
processing means for processing signals in the system; and
interconnecting means for interconnecting the processing means with a plurality of cache coherent links such that the performance characteristics of the system are determined solely by the interconnecting means.

20. A system, comprising:
a plurality of memories;
a plurality of input/output devices;
a plurality of processors, each processor being operably connected to at least one of the plurality of memories and at least one of the plurality of input/output devices; and
a backplane coupled to the plurality of processors in a specific configuration such that the performance characteristics of the system are determined solely by the specific configuration of the backplane, the backplane including a plurality of cache coherent links that directly interconnects every processor in the system.
